(19) United States
(12) Patent Application Publication
(10) Pub. No.: US 2016/0288005 A1
(43) Pub. Date: Oct. 6, 2016

(54) MODEL TRAIN BALLAST ADHESIVE AND A METHOD OF USING THE SAME

(71) Applicant: Leif-Eric HANSENS, Park Ridge, IL (US)

(72) Inventor: Leif-Eric HANSENS, Park Ridge, IL (US)

(21) Appl. No.: 15/091,915

(22) Filed: Apr. 6, 2016

Related U.S. Application Data
(60) Provisional application No. 62/133,257, filed on Apr. 6, 2015.

(51) Int. Cl. A63H 19/30; C09J 119/02

(52) U.S. Cl. CPC A63H 19/30; C09J 119/02

(57) ABSTRACT

An improved ballast adhesive for model train ballast beds is provided. The improved ballast adhesive and the method of using the same enable the adhered ballast beds to remain flexible after the curing of the ballast adhesive, facilitating the final flexible arrangement and securing of the adhered ballast beds in the desired layout of the model train set.

### CROSS-REFERENCE TO RELATED APPLICATION

This application claims the benefit of priority of U.S. provisional application No. 62/133,257, filed 6 Apr. 2015, the contents of which are herein incorporated by reference.

### BACKGROUND OF THE INVENTION

The present invention relates to model train set accessories and, more particularly, to a composition of an improved model train ballast adhesive and a method of using the same.

The ballast of a model train set (or actual train track) typically includes material and/or particulate used to form the bed of a railroad track or road, improving the stability thereof (in actual train tracks the ballast includes course stone or gravel, while in the model train set the ballast material is finer). In the context of model train sets, the ballast is glued in place so that loose ballast does not spread, either on the supporting surface or onto the model railroad track.

Current ballast glues, however, are difficult to apply and to work with after cured. In application, current ballast glue requires time-consuming priming and moisturizing. After curing, current ballast glues are not water soluble, making them difficult to work with. Particularly, current ballast glues make the ballast easy to chip and crack after curing. Moreover, current ballast glues result in a messy cleanup

As can be seen, there is a need for an improved model train ballast adhesive and an easy to apply method of using so that after curing, the ballast beds stay fully flexible, preventing after-curing chipping and cracking, especially when finalizing the arrangement and securing of the ballast beds for the model train set.

### SUMMARY OF THE INVENTION

In one aspect of the present invention, a model train ballast adhesive includes water; a natural liquid latex; and a dish soap.

In another aspect of the present invention, a method of adhering model train ballast, forming flexible ballast beds, includes the steps of: mixing water to a natural liquid latex, forming a water-latex admixture; mixing a soap to the water-latex admixture, forming a resultant ballast adhesive; and applying the ballast adhesive to predetermined portions of ballast beds.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention; and

FIG. 2 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved ballast adhesive for model train ballast beds that enable the adhered ballast beds to remain flexible after the curing of the ballast adhesive, facilitating the final flexible arrangement and securing of the adhered ballast beds in the desired layout of the model train set.

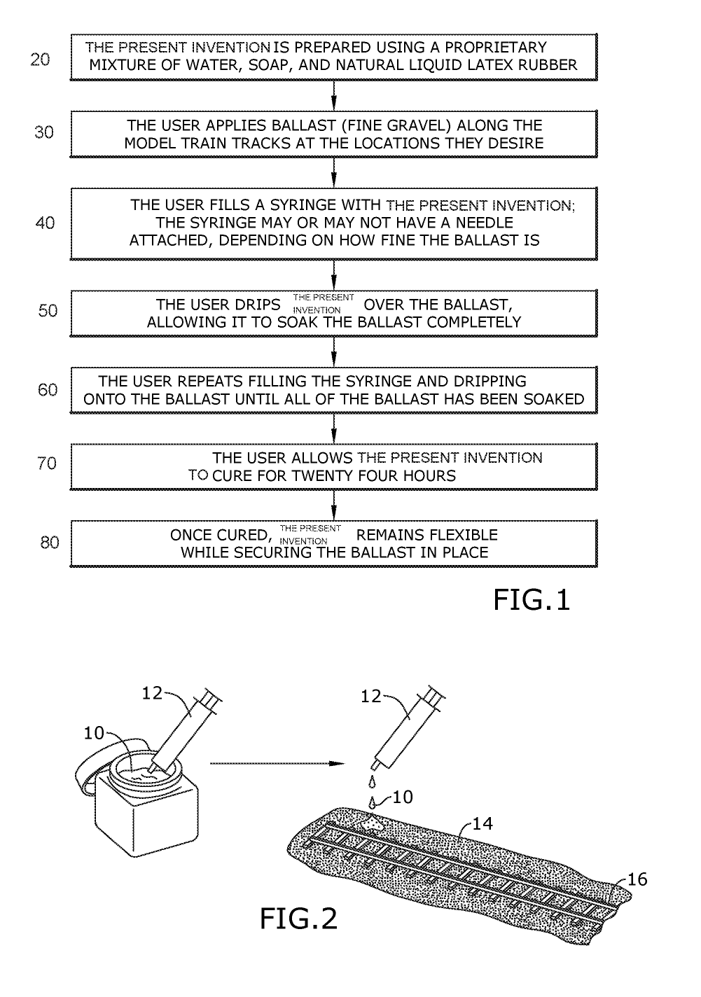

Referring to FIGS. 1 through 2, the present invention may include an improved ballast adhesive 10 for model train sets 16 and a method of using the same. The ballast adhesive 10 may include a mixture of water, soap and natural liquid latex, at a ratio designed especially for model train layout building. The process of forming the ballast adhesive may include mixing a ratio of water to a natural liquid latex between the range of 10 to 1 and 8 to 1, forming a water-latex admixture; and mixing a soap to the water-latex admixture between the range of 10 to 1 and 8 to 1, forming the resultant ballast adhesive 10.

The water is the carrier. The water is mixed with the natural liquid latex so as to form an adhesive after curing—i.e., after the water portion has vaporized. The soap is added to break the water tension and make the resultant ballast adhesive 10 soak into the ballast 14 easily. The water, natural liquid latex and the soap may all be added simultaneously. The soap may be dish soap. The natural liquid latex may include liquid latex rubber.

After curing of the applied ballast adhesive 10, the adhered ballast beds 14 may remain fully flexible along their length. This flexibility is advantageous over current ballast glues, as the resultant flexibility enables the adhered ballast beds 14 to be flexed and placed relative to each other for securing in desired layouts. Furthermore, the resultant flexibility may avoid to create a sound bridge which transfers sound of the wheels of the model train to the layout of the frame.

The ballast adhesive 10 may be applied using an applicator 12, such as a syringe, to urge a predetermined amount of the ballast adhesive 10 onto a portion of the ballast 14, as illustrated in FIG. 2

A method of using the present invention may include providing the ballast adhesive 10 mentioned above. The ballast adhesive 10 may be prepared in the predetermined mixture of water, soap and natural liquid latex, in step 20.

In step 30, a user may place model train ballast 14 along the model train tracks 16, typically forming ballast beds, as illustrated in FIG. 2.

In step 40, the user may employ the applicator 12 to apply the ballast adhesive 10 to predetermined portions of the ballast 14. The applicator 12 may include a needle applicator depending on the fineness of the ballast 14 being adhered.

In step 50, the user may drip the ballast adhesive 10 over the ballast 14, allowing it to soak into the ballast 14 completely.

In step 60, the user may repeat filling and utilizing the applicator 12 to drip the ballast adhesive 10 until all of the predetermined portions of the ballast 14 are soaked.

In step 70, the user may allow the ballast adhesive 10 to cure for approximately 24 hours.

In step 80, once cured, the ballast adhesive 10 remains flexible while securing the ballast 14 in place in desired arrangements when designing and laying out the model train set 16, possibly through multiple iterations.

In an alternative use, the ballast adhesive 10 may be used to glue any lightweight objects or particulate together when post-curing flexibility would be advantageous.

It should be understood, of course, that the foregoing relates to exemplary embodiments of the invention and that modifications may be made without departing from the spirit and scope of the invention as set forth in the following claims.

What is claimed is:

1. A model train ballast adhesive, comprising:
water;
a natural liquid latex; and
a soap.

2. The model train ballast adhesive of claim 1, wherein the soap comprises dish soap.

3. The model train ballast adhesive of claim 1, further comprising a ratio of water to the natural liquid latex between the range of 10 to 1 and 8 to 1, forming a water-latex admixture.

4. The model train ballast adhesive of claim 1, further comprising a ratio of the soap to the water-latex admixture between the range of 10 to 1 and 8 to 1.

5. The model train ballast adhesive of claim 4, wherein the soap comprises dish soap.

6. A method of adhering model train ballast, forming flexible ballast beds, comprising the steps of:
mixing a ratio of water to a natural liquid latex between the range of 10 to 1 and 8 to 1, forming a water-latex admixture;
mixing a soap to the water-latex admixture between the range of 10 to 1 and 8 to 1, forming a resultant ballast adhesive; and
applying the ballast adhesive to predetermined portions of ballast beds.

7. The method of claim 6, further comprising the step of providing an applicator to apply the ballast adhesive.

8. The method of claim 7, further comprising the step of providing a needle to the applicator to apply the ballast adhesive.

9. The method of claim 8, wherein the soap is dish soap.

10. The method of claim 9, further comprising the step of curing the ballast adhesive for at least twenty-four hours.

11. A method of adhering model train ballast, forming flexible ballast beds, comprising the steps of:
mixing water to a natural liquid latex, forming a water-latex admixture;
mixing a soap to the water-latex admixture, forming a resultant ballast adhesive; and
applying the ballast adhesive to predetermined portions of ballast beds.

12. The method of claim 11, wherein the soap is dish soap.
